(19) United States
(12) Patent Application Publication
(10) Pub. No.: US 2014/0183865 A1
(43) Pub. Date: Jul. 3, 2014

(54) Alternative energy sourse

(71) Applicant: Vladimir Poutchkov, Staten Island, NY (US)

(72) Inventor: Vladimir Poutchkov, Staten Island, NY (US)

(21) Appl. No.: 13/429,330

(22) Filed: Dec. 28, 2012

(51) Int. Cl. H02K 7/18

(52) U.S. Cl. CPC H02K 7/1823; Y10S 415/916; F03B 17/04
USPC 290/52; 415/916

(57) ABSTRACT

The present invention may be used for generating electricity using the change in air pressure generated by a difference in altitude. Air current is created in a tube due to its position, having its openings at different elevations above sea level. The bottom end of the tube being in a zone of higher pressure, and the top end being in a zone of lower pressure. The generated air flow inside the tube moves from the higher pressure zone to the lower pressure zone, forcing a propeller situated inside the tube and connected to an electric generator to spin and generate an electric current.

### BACKGROUND OF THE INVENTION

This invention relates to apparatus for generating electric current using air current. The Altitude Influenced Air Current Electric Generator, uses natural air current created in a pipe due to a change in altitude and air pressure, a wind turbine inside the pipe is forced to spin by the naturally occurring air flow in the pipe.

Use of wind turbines to generate electric current may be known however, this devise unlike wind turbines uses the change of altitude and air pressure to generate air current inside of a pipe structure, by elevating one end over the other placing the lower opening of the pipe into a zone of higher air pressure, and the upper opening of the pipe into a zone of lower pressure.

### SUMMARY OF THE INVENTION

The present invention is directed to apparatus for generating electrical current. A tube body may have a polarity of sizes. It can be made of various hard or soft materials, and vary in width and length, it can be used any place that allows a surface for installment of the elevated pipe structure. Turbine propeller inside the tube can also be made of various materials such as metal, plastic, rubber, wood or any other suitable material, the same goes for the axe that connects the turbine to the generator. The present invention functions by generating electricity using the change in air pressure generated by a difference in altitude. Air current is created in a tube due to its position, having its openings at different elevations above sea level. The bottom end of the tube being in a zone of higher pressure, and the top end being in a zone of lower pressure. The generated air flow inside the tube moves from the higher pressure zone to the lower pressure zone, forcing a propeller situated inside the tube and connected to an electric generator to spin and generate an electric current.

### BRIEF DESCRIPTION OF THE DRAWINGS

FIG. 1 illustrates a view from above showing the turbine blades and the axe connecting the turbine with the generator inside the pipe cylinder.

FIG. 2 illustrates a three dimensional side view of the pipe, in-closed turbine inside the pipe, in-closed generator inside the pipe, connectors to a rele, which is connected to an accumulator and to the consumer, and air current illustrated with arrows going in from the higher pressure zone and coming out of the opening in the lower pressure zone.

FIG. 3 illustrates the view from the bottom, showing the wires connected to the generator inside the pipe and the central axe rod connecting the generator and the turbine.

### DETAILED DESCRIPTION

The following detailed description represents the best currently contemplated modes for carrying out the invention. The description is not to be taken in a limiting sense, but is made merely for the purpose of illustrating the general principles of the invention.

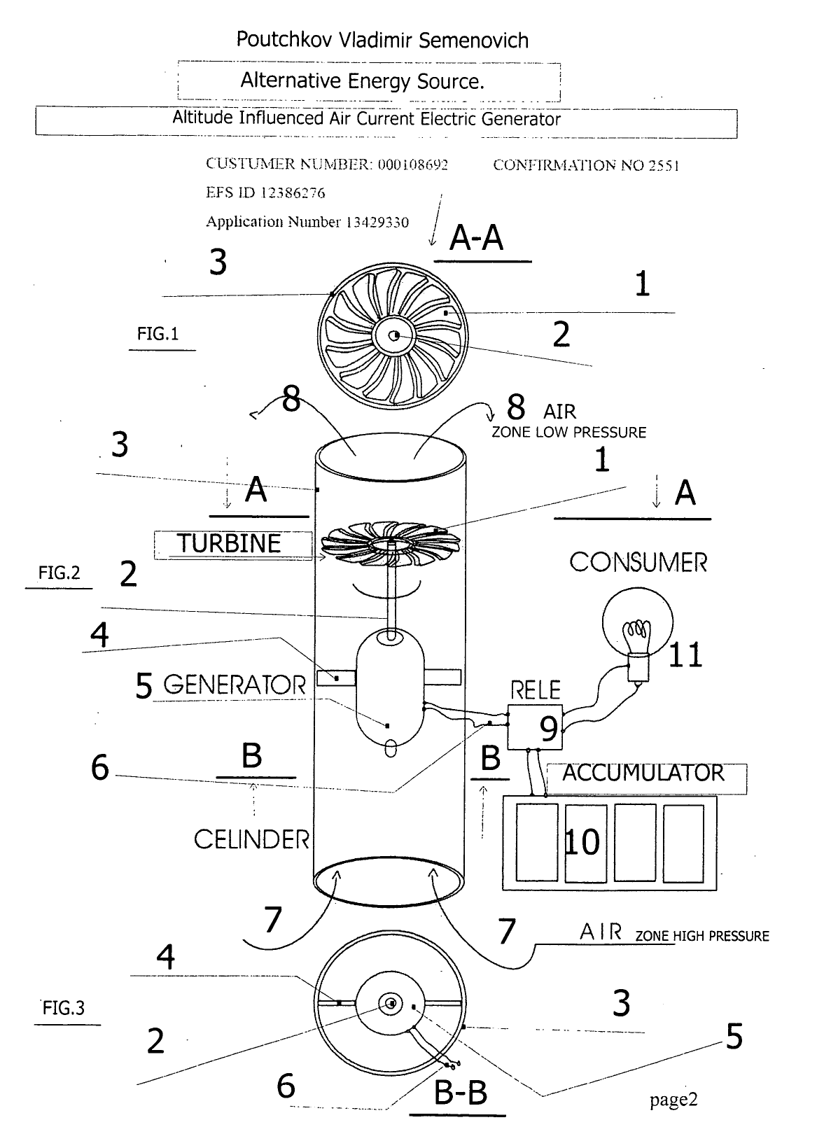

Referring to FIG. 1 illustrates a view from above showing the turbine blades and the axe connecting the turbine with the generator inside the cylinder of the pipe. In the image labeled #1 are the turbine blades, labeled #2 axe rod that connects the turbine to the generator. Labeled #3 the corpus of the pipe in which the generator and the turbine are located.

FIG. 2 in the center of the blueprint illustrates a three dimensional side view. Labeled #1 are the turbine blades, which are forced to spin by its interaction with the air current. Labeled #2 is the metal or plastic axe (rod) that's connecting the turbine to the generator and transferring the rotational movement from the turbine to the generator.

Labeled #3 is the corpus of the pipe, through which the air current travels, that accurse naturally due to the difference in altitude between the top and bottom ends of the pipe.

Labeled #4 shows the connecting elements of the generator to the internal walls of the pipe, which consist of either metal or plastic sheets the edges of which are facing the direction of the air current so that it doesn't effect it's flow.

Labeled #5 is the generator of the electric current can be used as a generator of a constant electric current, as well as a generator of an alternating electric current. The generator receives a rotational momentum from the axe of the turbine.

Labeled #6 electric wires connecting the generator to the external consumers.

Labeled #7 is an illustration of the direction of air current flow travelling from the zone of higher air pressure.

Labeled #8 shows the air current flow exiting the pipe into a zone of lower air pressure.

Labeled #9 is the rele which can be used to switch the electric current over to the accumulator when it is not in use. The system can work directly without rele.

Labeled #10 is the electric accumulator.

Labeled #11 is the consumer.

The image labeled FIG. 3 illustrates the view from the bottom.

Labeled #2 is the axe of the electric generator.

Labeled #3 is the corpus of the pipe.

Labeled #4 are the metal sheets connecting the electric generator to the walls of the pipe.

Labeled #5 is the electric generator.

Labeled #6 are the wires connecting the generator to the consumer.

While the invention has been particularly shown and described with respect to the illustrated embodiments thereof, it will be understood by those skilled in the art that the foregoing and other changes in form and details may be made therein without departing from the spirit and scope of the invention.

I claim:

1. An apparatus for generating electrical current using air pressure generated by a difference in altitude comprising:
a hollow tube body with openings at both ends, having a turbine and a generator attached on the inside of said body;
said body having width and length required for attachment to any outdoor structure;
a said turbine is attached to a generator by an axe;

2. The apparatus in claim 1 wherein said turbine and generator are attached to the internal walls of said pipe body with sheets made of metal or any other flat suitable material. The said attachment sheets face the openings of the tube with their flat edges not to interfere with airflow.

3. The said generator is connected to the consumer with wires, and can also be connected to a rele which can be used to switch the electric current over to the accumulator when it is not in use; the system can work directly without the rele.
